(19) United States
(12) Patent Application Publication
(10) Pub. No.: US 2008/0297539 A1
(43) Pub. Date: Dec. 4, 2008

(54) LIQUID CRYSTAL DISPLAY AND METHOD OF DRIVING THE SAME

(75) Inventors: Kyung-wook KIM, Seoul (KR); Kye-hun LEE, Cheonan-si (KR); Min-wook PARK, Seongnam-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/130,499

(22) Filed: May 30, 2008

(30) Foreign Application Priority Data
May 31, 2007 (KR) 10-2007-0053431

(51) Int. Cl. G09G 5/10

(52) U.S. Cl. 345/690

(57) ABSTRACT

A liquid crystal display which can selectively display an image having a high visibility or an image having a high luminance. The liquid crystal display includes a panel unit having a plurality of gate lines, a plurality of data lines, and a plurality of pixels, each pixel being coupled to a gate line and a data line and having a plurality of sub-pixels, a data-drive unit providing data signals to the data lines, and a gate-drive unit providing gate signals to the gate lines in a first order or in a second order. When the gate-drive unit provides the gate signals in the first order, the sub-pixels of a respective pixel are charged with different pixel voltages, and when the gate-drive unit provides the gate signals in the second order, the sub-pixels of the respective pixel are charged with substantially the same pixel voltage.

This application claims priority to Korean Patent Application No. 10-2007-0053431, filed on May 31, 2007, and all the benefits accruing therefrom under 35 U.S.C. § 119, the contents of which in its entirety is herein incorporated by reference.

### BACKGROUND OF THE INVENTION

1. Field of the Invention The present invention relates to a liquid crystal display and a method of driving the same.

2. Description of the Prior Art

Generally, a liquid crystal display (“LCD”) includes a liquid crystal display panel (“LCD panel”) which includes a lower substrate, an upper substrate provided opposite to the lower substrate, and a liquid crystal layer formed between the lower substrate and the upper substrate. The LCD panel further includes a plurality of gate lines, a plurality of data lines, and a plurality of pixels connected to the gate lines and the data lines, respectively.

The LCD has an inferior viewing angle in comparison to other display devices. In order to improve the viewing angle of the LCD, many methods have been attempted. According to a conventional method, one pixel includes two sub-pixels, and different voltages are applied to the two sub-pixels to form domains having different grayscales in the respective sub-pixels. Therefore, since a user recognizes an intermediate value of the voltages of the two sub-pixels, deterioration of a side viewing angle of the LCD, which occurs due to distortion of a gamma curve below an intermediate grayscale, is prevented. Accordingly, a side visibility of the LCD can be improved.

In applying different grayscale voltages to the two sub-pixels, several conventional methods may be used. According to one conventional method, for example, the different grayscale voltages are applied to the two sub-pixels using a charge share between the two sub-pixels. This method uses the charge share and has the drawback in that the luminance of the two sub-pixels becomes low in comparison to other conventional methods which do not use the charge share. In the case where it is important to heighten the luminance of the image being displayed, rather than the visibility, in answer to a user's need, the method of applying the different grayscale voltages to the two sub-pixels using the charge share causes problems due to the image having the low luminance.

### BRIEF SUMMARY OF THE INVENTION

The present invention has been made in an effort to sole the above stated problems, and aspects of the present invention provide a liquid crystal display which can selectively display an image having a high visibility or an image having a high luminance, and a method of driving the same.

According to an exemplary embodiment, the present invention provides a liquid crystal display which includes a panel unit having a plurality of gate lines, a plurality of data lines, and a plurality of pixels, each pixel being coupled to a gate line and a data line and having a plurality of sub-pixels, a data-drive unit supplying a plurality of data signals to the plurality of data lines, and a gate-drive unit providing a plurality of gate signals to the plurality of gate lines in a first order or in a second order, when the gate-drive unit provides the gate signals in the first order, the plurality of sub-pixels of the respective pixel are charged with different pixel voltages, and when the gate-drive unit provides the gate signals in the second order, the plurality of sub-pixels of the respective pixel are charged with substantially a same pixel voltage.

According to another exemplary embodiment, the present invention provides a liquid crystal display which includes a panel unit having a plurality of gate lines, a plurality of data lines, and a plurality of pixels, each pixel being coupled to a gate line and a data line and having a plurality of sub-pixels, a timing-control unit which receives image data, provides a color signal for an image display in a Last-In First-Out (“LIFO”) manner, and provides a vertical-drive-start signal, a data-drive unit which receives the color signal and provides a plurality of data signals to the plurality of data lines, and a gate-drive unit which receives the vertical-drive-start signal and provides a plurality of gate signals to the plurality of gate lines.

According to still another exemplary embodiment, the present invention provides a method of driving a liquid crystal display. The method includes providing a panel unit having a plurality of gate lines, a plurality of data lines, and a plurality of pixels, each pixel being coupled to a gate line and a data line and having a plurality of sub-pixels, providing a plurality of data signals to the plurality of data lines, charging the plurality of sub-pixels of a respective pixel with different pixel voltages by providing a plurality of gate signals to the plurality of gate lines in a first order, and charging the plurality of sub-pixels of the respective pixel with substantially a same pixel voltage by providing a plurality of gate signals in a second order which is different from the first order.

### BRIEF DESCRIPTION OF THE DRAWINGS

The above and/or other aspects, features, and advantages of the present invention will become more apparent from the following detailed description when taken in conjunction with the accompanying drawings, in which:

FIG. 1 is a block diagram illustrating an exemplary embodiment of a liquid crystal display according to the present invention;

FIG. 2 is a view illustrating an exemplary embodiment of a pixel array structure of the panel unit of FIG. 1, according to the present invention;

FIG. 3 is a view illustrating another exemplary embodiment of a pixel array structure of the panel unit of FIG. 1, according to the present invention;

FIG. 4 is a view illustrating an exemplary embodiment of the gate-drive unit of FIG. 1, according to the present invention;

FIG. 5 is a view illustrating an exemplary embodiment of the gate drive control unit of FIG. 1, according to the present invention;

FIG. 6 is a view illustrating an exemplary embodiment of the correlation among outputs of the gate drive control unit of FIG. 1, according to the present invention; and

FIG. 7 is a view illustrating an exemplary embodiment of the grayscale-voltage-generation unit of FIG. 1, according to the present invention.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

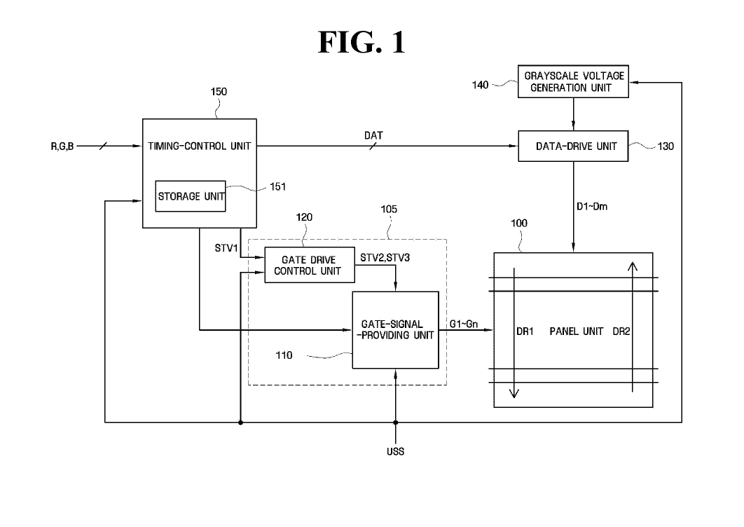

FIG. 1 is a block diagram illustrating an exemplary embodiment of a liquid crystal display according to the present invention.

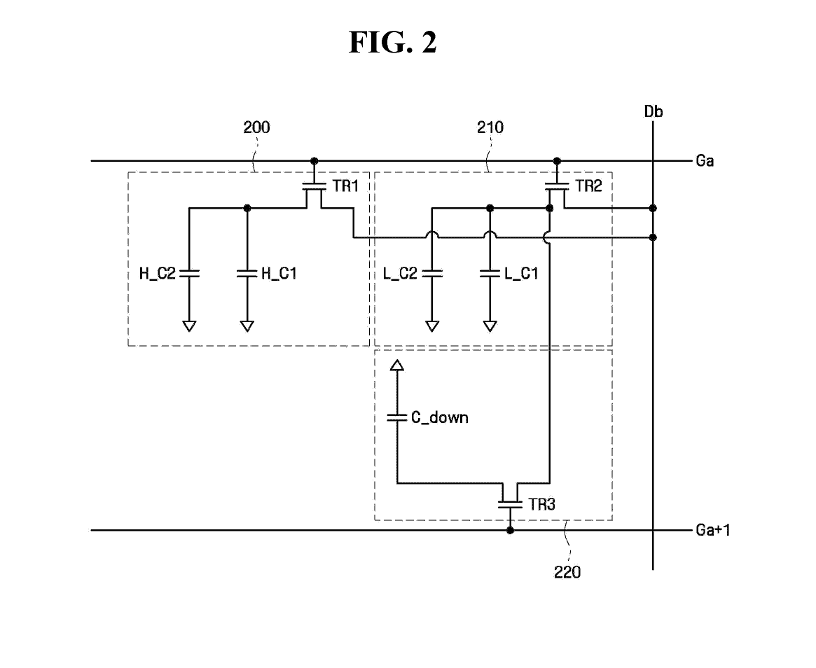

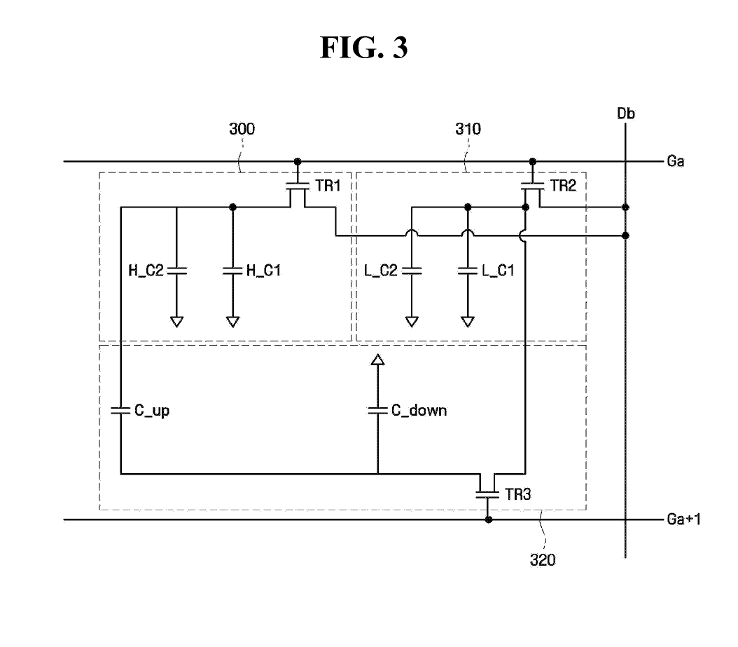

Referring to FIG. 1, the liquid crystal display (“LCD”) according to an exemplary embodiment of the present invention includes a panel unit 100, a gate-drive unit 105, a grayscale-voltage-generation unit 140, and a timing-control unit 150. The panel unit 100 includes a plurality of gate lines G1 to Gn, a plurality of data lines D1 to Dm, and a plurality of pixels. The plurality of gate lines G1 to Gn may be first to n-th (where, n is an integer) gate lines successively arranged from a first side (e.g., an upper side) to a second side (e.g., a lower side) of the panel unit 100. The plurality of data lines D1 to Dm may be first to m-th data lines successively arranged from a third side (e.g., a left side) to a fourth side (e.g., a right side) of the panel unit 100. The pixels may be coupled to the gate lines G1 to Gn and the data lines D1 to Dm, respectively. According to an exemplary embodiment, the respective pixel may be composed of a plurality of sub-pixels; for example, two sub-pixels. The exemplary structure of the panel unit 100 will be described later with reference to FIGS. 2 and 3.

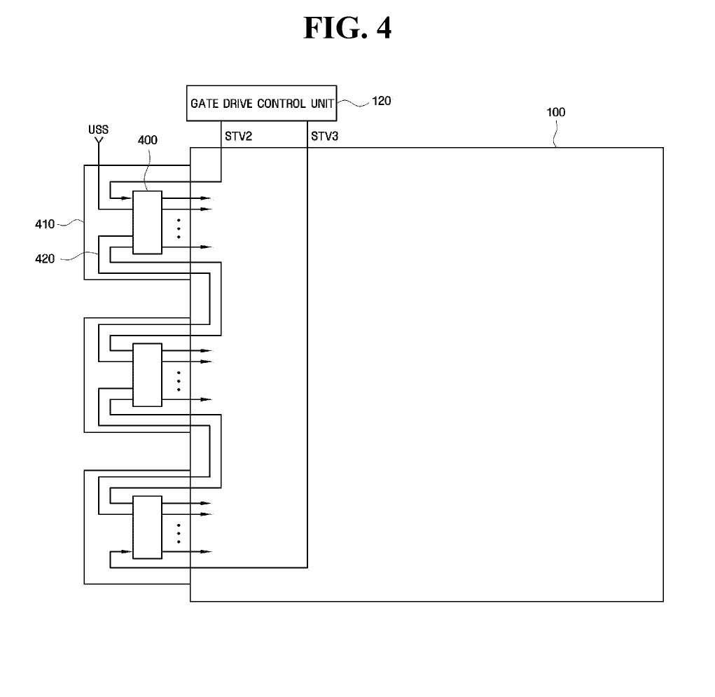

According to an exemplary embodiment, the gate-drive unit 105 provides a plurality of gate signals to the gate lines G1 to Gn in the first order DR1 or in the second order DR2. The first order DR1 may be the order counted from the first gate line G1 to the n-th gate line Gn (e.g., from the upper side to the lower side), and the second order DR2 may be the order counted from the n-th gate line Gn to the first gate line G1 (e.g., from the lower side to the upper side). The construction of the gate-drive unit 105 will be described later with reference to FIG. 4.

According to an exemplary embodiment, when providing the gate signals in the first order DR1 in the LCD according to exemplary embodiments of the present invention, the sub-pixels of the respective pixel may be charged with different pixel voltages, and when providing the gate signals in the second order DR2, the sub-pixels of the respective pixel may be charged with substantially the same pixel voltage. According to exemplary embodiments of the present invention, a high visibility can be obtained when providing the gate signals in the first order DR1, and a high luminance can be obtained when providing the gate signals in the second order DR2. Accordingly, the user can selectively view an image having a high visibility or an image having a high luminance. This feature of the present invention will be described later with reference to FIGS. 2 and 3.

In order to perform the above-described operation, according to an exemplary embodiment, the gate-drive unit 105 may include a gate-signal-providing unit 110 and a gate drive control unit 120.

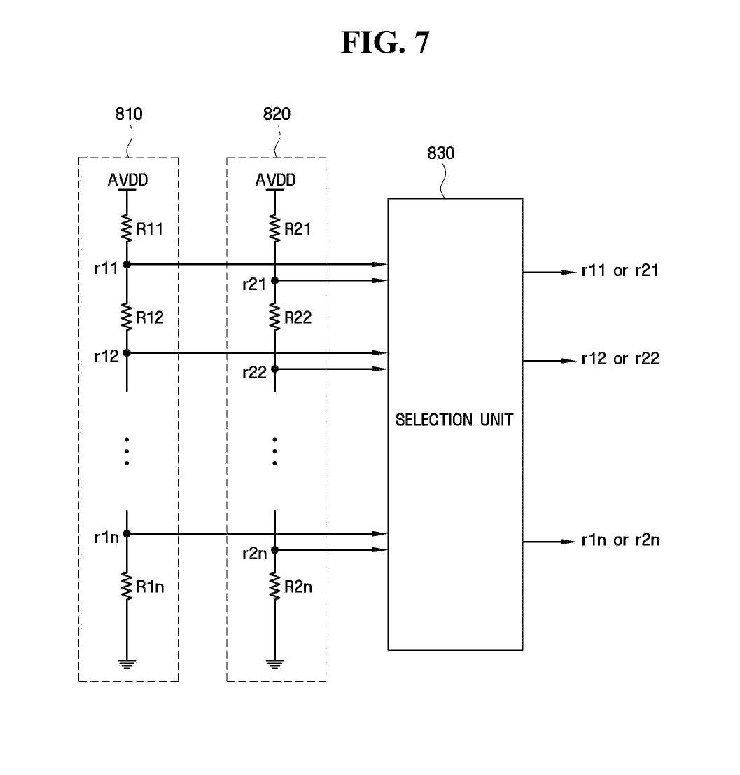

Here, the gate drive control unit 105 receives a first vertical-drive-start signal STV1 from a timing-control unit 150 and a user-selection signal USS from a user interface (not shown), and selectively outputs a second vertical-drive-start signal STV2 or a third vertical-drive-start signal STV3 from the gate drive control unit 120 to the gate-signal-providing unit 110. In another exemplary embodiment of the present invention, the second vertical-drive-start signal STV2 and the third vertical-drive-start signal STV3 may be same signal. The detailed circuit construction and operation of the gate drive control unit 105 will be described later with reference to FIGS. 6 and 7. Here, the user-selection signal USS is a signal inputted by a user through a user interface, and differs depending on whether the user selects a view an image having a high visibility or an image having a high luminance.

When the gate-signal-providing unit 110 receives the second vertical-drive-start signal STV2, it then provides the plurality of gate signals through the gate lines G1 to Gn in the first order DR1, and when it receives the third vertical-drive-start signal STV3, it provides the plurality of gate signals through the gate lines G1 to Gn in the second order DR2.

A data-drive unit 130 provides data signals to the data lines D1 to Dm. Specifically, the data-drive unit 130 receives the data signals in digital form through the data lines D1 to Dm, and converts the data signals received through the data lines D1 to Dm into analog signals to output the analog data signals to the panel unit 100.

The grayscale-voltage-generation unit 140 provides a grayscale voltage group for generating the data signals D1 to Dm to the data-drive unit 130. Particularly, in the LCD according to exemplary embodiments of the present invention, the grayscale-voltage-generation unit 140 can provide different grayscale voltage groups. According to an exemplary embodiment, when the gate-drive unit 105 provides the gate signals G1 to Gn in the first order DR1, the grayscale-voltage-generation unit 140 provides a first grayscale voltage group, and when the gate-drive unit 105 provides the gate signals G1 to Gn in the second order DR2, the grayscale-voltage-generation unit 140 provides a second grayscale voltage group which is different from the first grayscale voltage group. The grayscale-voltage-generation unit 140 determines whether to provide the first grayscale voltage group or the second grayscale voltage group, in accordance with the user-selection signal USS it receives.

According to exemplary embodiments, the sub-pixels of the respective pixel have the same or different pixel voltages depending on their driving method, and thus, the grayscale characteristic of the panel unit 100 may be changed. That is, in order to select the corresponding grayscale voltage group according to the changeable grayscale characteristic, the grayscale-voltage-generation unit 140 provides the different grayscale voltage groups. The grayscale-voltage-generation unit 140 as described above will be described later with reference to FIG. 8.

The timing-control unit 150 receives R, G, and B image data from a graphics card to be displayed on a display screen and others, and outputs a color signal DAT for an image display to the data-drive unit 130. The timing-control unit 150 also outputs the first vertical-drive-start signal STV1 to the gate drive control unit 120 of the gate-drive unit 105. According to an exemplary embodiment, the RGB image data matches the color signal DAT for the image display.

The timing-control unit 150 outputs the color signal DAT in a First-In First-Out (“FIFO”) manner or in a Last-In First-Out (“LIFO”) manner. According to an exemplary embodiment, when the timing-control unit 150 operates in a FIFO manner, it first outputs the color signal DAT which matches the first input RGB image data, and lastly outputs the color data DAT which matches the last input RGB image data. In the case where the timing-control unit 150 operates in a LIFO manner, it lastly outputs the color signal DAT which matches the first input RGB image data, and first outputs the color data DAT which matches the last input RGB image data.

When the gate-drive unit 105 provides the gate signals G1 to Gn in the first order DR1 (e.g., from the upper side to the lower side), the timing-control unit 150 may output the color signal DAT in the order of the timing-control unit 150's reception of the RGB image data (e.g., in a FIFO manner). When the gate-drive unit 105 provides the gate signals G1 to Gn in the second order DR2 (e.g., from the lower side to the upper side), a desired image is not displayed when the timing-control unit 150 outputs the color signal DAT in the order of the timing-control unit 150's reception of the RGB image data. Accordingly, the timing-control unit 150 outputs the color signal DAT in the opposite order to the order of reception of the RGB image data (e.g., in a LIFO manner).

In order to output the color signal in a LIFO manner, according to an exemplary embodiment, the timing-control unit 150 may include a storage unit 151. For example, the storage unit 151 stores the image data for display of one frame image.

In addition, the timing-control unit 150 receives the user-selection signal USS, and determines whether to operate in a FIFO manner or in a LIFO manner according to the user-selection signal.

Although not illustrated in the drawing, the timing-control unit 150 receives control signals such as a vertical sync signal Vsync, a horizontal sync signal Hsync, and a data enable signal DE, for example, and outputs the color signal, a signal used for a signal control in the data-drive unit 130, and a signal used for a signal control in the gate-drive unit 105. A detailed description of all of the parts related to the control signals except for the vertical drive control signal has been omitted.

FIG. 2 is a view illustrating an example of a pixel array structure of the panel unit of FIG. 1.

Referring to FIG. 2, a pixel in the panel unit 100 includes gate lines Ga and Ga+1, a data line Db, a first sub-pixel 200, a second sub-pixel 210, and a voltage-adjustment unit 220.

The gate lines Ga and Ga+1 (where, 1≦a≦n−1) receive gate signals, and the data line Db (where, 1≦b≦m) receives a data signal.

According to an exemplary embodiment, the first sub-pixel 200 includes a first liquid crystal capacitor H_C1, a first storage capacitor H_C2, and a first switching element TR1. Here, the control terminal of the first switching element TR1 is connected to the gate line Ga, the input terminal thereof is connected to the data line Db, and the output terminal thereof is connected to the first liquid crystal capacitor H_C1 and the first storage capacitor H_C2 which maintains charge being for the first liquid crystal capacitor H_C1.

According to an exemplary embodiment, the second sub-pixel 210 includes a second liquid crystal capacitor L_C1, a second storage capacitor L_C2, and a second switching element TR2. The control terminal of the second switching element TR2 is connected to the gate line Ga, the input terminal thereof is connected to the data line Db, and the output terminal thereof is connected to the second liquid crystal capacitor L_C1 and the second storage capacitor L_C2 which maintains the charge being charged in the second liquid crystal capacitor L_C1.

The voltage-adjustment unit 220 includes a down capacitor C_down and a third switching element TR3. The control terminal of the third switching element TR3 is connected to the gate line Ga+1, the output terminal thereof is connected to the down capacitor C_down, and the input terminal thereof is connected to the output terminal of the second switching element TR2.

Hereinafter, the operation of the pixel as illustrated in FIG. 2 will be described in more detail. First, an exemplary embodiment where the gate signals are applied in the first order, i.e., from the first gate line G1 to the n-th gate line Gn, or from the upper side to the lower side, will now be described.

When the gate signal is applied to the gate line Ga, the first and second switching elements TR1 and TR2 of the first and second sub-pixels 200 and 210 are turned on. Therefore, a charge as much as the voltage which corresponds to the data signal being applied to the data line Db is stored in the first and second liquid crystal capacitors H_C₁ and L_C1, and the amounts of charge in the first and second liquid crystal capacitors H_C₁ and L_C1 are maintained for a time corresponding to one frame by the first and second storage capacitors H_C2 and L_C2.

When the gate signal is applied to the next-stage gate line Ga+1 after the gate signal is applied to the gate line Ga, the third switching element TR3 is turned on. When the third switching element TR3 is turned on, charge sharing occurs among the second liquid crystal capacitor L_C1, the second storage capacitor L_C2, and the down capacitor C_down.

Since the charge sharing in the second sub-pixel 210 is produced by the voltage-adjustment unit 220, the amounts of charge being stored in the liquid crystal capacitors H_C₁ and L_C1 of the first and second sub-pixels 200 and 210 differ. Accordingly, the grayscale of the first sub-pixel 200 becomes different from the grayscale of the second sub-pixel 210. According to an exemplary embodiment, the grayscale of the second sub-pixel 210 is lower than that of the first sub-pixel 200.

Next, according to an exemplary embodiment where the gate signals are applied in the second order, i.e., from the n-th gate line Gn to the first gate line G1, or from the lower side to the upper side, will be described.

When the gate signals are successively applied from the gate line Gn located at the lowermost end of the panel unit 100 to the gate line G1 located at the uppermost end of the panel 100, the first sub-pixel 200 and the second sub-pixel 210 are charged with the same pixel voltage. That is, the amount of charge in the down capacitor C_down does not affect the operation of the first and second sub-pixels. When the gate signal is first applied to the gate line Ga+1 and the third switching element TR3 is turned on, the charge sharing occurs among the down capacitor C_down, the second liquid crystal capacitor L_C1, and the second storage capacitor L_C2. However, when the gate signal is applied to the gate line Ga, the first and second switching elements TR1 and TR2 are turned on, and the first and second liquid crystal capacitors H_C1 and L_C1 are charged with the voltage which corresponds to the data signal being applied to the data line Db. The charged state of the first and second liquid crystal capacitors H_C 1 and L_C1 is maintained by the first and second storage capacitors H_C2 and L_C2, respectively. That is, irrespective of the charge sharing with the down capacitor C_down, the charge which corresponds to the voltage of the gate signal is charged in the first and second liquid crystal capacitors H_C1 and L_C1. When applying the gate voltage to the gate lines Ga and Ga+1 of the panel unit 100 in the second order, the luminance of a pixel including the first and second sub-pixels 200 and 210 is heightened in comparison to when the gate voltage is applied in the first order.

FIG. 3 is a view illustrating another exemplary embodiment of a pixel array structure of a panel unit of FIG. 1, according to the present invention.

Referring to FIG. 3, a pixel in the panel unit 100 according to the present invention includes gate lines Gn and Gn+1, a data line Dn, a first sub-pixel 300, a second sub-pixel 310, and a voltage-adjustment unit 320. Since the gate lines, the data line, the first sub-pixel 300, and the second sub-pixel 310 as illustrated in FIG. 3 are similar to those as illustrated in FIG. 2, the detailed description thereof will be omitted.

The voltage-adjustment unit 320 includes a down capacitor C_down, an up capacitor C_up, and a third switching element TR3. The control terminal of the third switching element TR3 is connected to the gate line Ga+1, the output terminal thereof is connected to the down capacitor C_down and the up capacitor C_up, and the input terminal thereof is connected to the output terminal of the second switching element TR2.

The operation of the pixel as illustrated in FIG. 3 is described in more detail in the following.

When the gate signals are successively applied to the gate line Ga and the next-stage gate line Ga+1, the first and second switching elements TR1 and TR2 of the first and second sub-pixels 300 and 310 are turned on. The charge as much as the voltage which corresponds to the data signal being applied to the data line Db is charged in the first and second liquid crystal capacitors H_C1 and L_C1. Also, a specified amount of charge is stored in the down capacitor C_down and the up capacitor C_up connected in series through the first switching element TR1.

Then, when the gate signal is applied to the gate line Ga+1, the amount of charge in the first liquid crystal capacitor H_C 1 is shared by the up capacitor C_up and the down capacitor C_down connected in series. The amount of charge in the second liquid crystal capacitor L_C1 is shared by the down capacitor C_down. Accordingly, the amount of charge in the first liquid crystal capacitor H_C1 becomes different from the amount of charge in the second liquid crystal capacitor L_C1, and this causes the grayscale of the first sub-pixel 300 to be different from the grayscale of the second sub-pixel 310.

In contrast, when the gate signals are applied in the order of the gate line Ga+1 and the gate line Ga, the amounts of charge in the up capacitor C_up and the down capacitor C_down do not affect the operation of the sub-pixels in the similar manner to those as shown in FIG. 2.

When the gate signal is applied to the gate line Ga, the first and second switching elements TR1 and TR2 are turned on, and the first and second liquid crystal capacitors H_C₁ and L_C1 are charged with the voltage which corresponds to the data signal being applied to the data line Db. The charged state of the first and second liquid crystal capacitors H_C₁ and L_C1 is maintained by the first and second storage capacitors H_C2 and L_C2.

As described above, according to the order of the panel unit 100's applying of the gate signals to the gate lines Ga and Ga+1, the visibility is increased or the luminance is increased.

FIG. 4 is a view illustrating an example of the gate-drive unit of FIG. 1.

Referring to FIG. 4, the gate-signal-providing unit 110 includes a plurality of integrated circuits 400, and the respective integrated circuit 400 is mounted on a taper carrier package (“TCP”) unit 410. The neighboring integrated circuits 400 mounted on a plurality of TCP units 410 are connected to one another through interconnection lines 420 in order to transmit a clock signal and control signals such as gate turn-on/off level signals. The respective integrated circuit 400 of the gate-signal-providing unit 110 applies the gate signals to a predetermined number of gate lines. For example, the 256th integrated circuit 400 applies the gate signals to 256 gate lines.

The gate-signal-providing unit 110 applies the gate signals to the gate lines according to vertical-drive-start signals STV2 and STV3. As described above, the order of applying of the gate signals to the plurality of gate lines G1 to Gn included in the panel unit 100 is changed according to the user-selection signal USS. Accordingly, one vertical-drive-start signal, for example, the second vertical-drive-start signal STV2 should be connected to the integrated circuit 400 which applies the gate signal to the uppermost gate line of the panel unit 100, and the other vertical-drive-start signal, for example, the third vertical-drive-start signal STV3 should be connected to the integrated circuit 400 which applies the gate signal to the lowermost gate line of the panel unit 100. In accordance with the second and third vertical-drive-start signals STV2 and STV3, the applying of the gate signals can start from the uppermost gate line or the lowermost gate line of the panel unit 100.

Since the second and third vertical-drive-start signals STV2 and STV3 are related to time points where the gate signals are applied, the integrated circuits 400 determine the order of applying the gate signals in accordance with the user-selection signal USS inputted thereto. According to the current exemplary embodiment, when the user-selection signal USS for applying the gate signals in the order counted from the uppermost gate line to the lowermost gate line of the panel unit 100 is inputted, the respective integrated circuits 400 should output the gate signals to match the order. Accordingly, the order of the integrated circuit 400's outputting of the gate signals to the gate lines is changed according to the user-selection signal USS. The user-selection signal USS is connected to one of the plurality of integrated circuits 400, and is transmitted to other integrated circuits 400 through the interconnection lines 420.

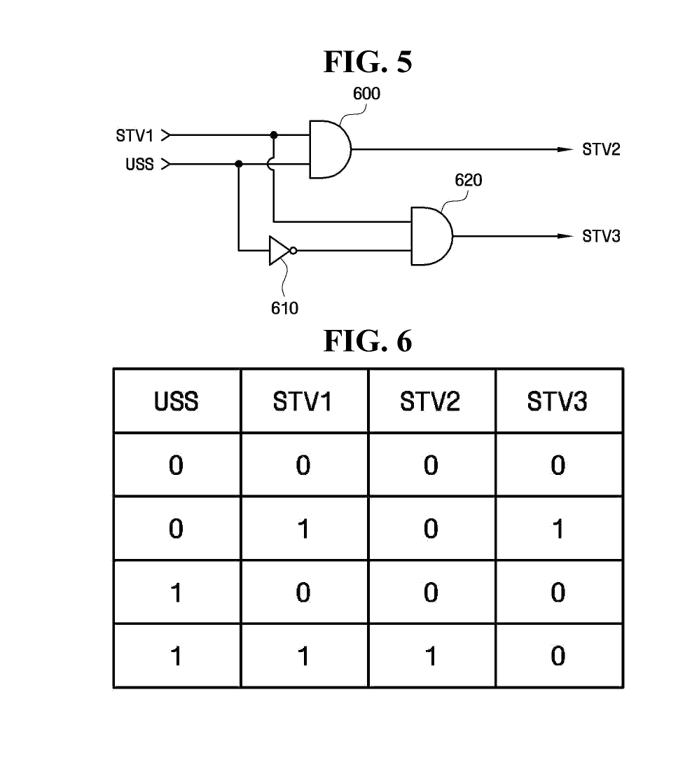

FIG. 5 is a view illustrating an exemplary embodiment of a gate drive control unit of FIG. 1, and FIG. 6 is a view illustrating an exemplary embodiment of the correlation among outputs of the gate drive control unit of FIG. 1, according to the present invention.

Referring to FIG. 5, the second vertical-drive-start signal STV2 is the output of a first AND gate 600 which receives as its inputs, the first vertical-drive-start signal STV1 and the user-selection signal USS. The third vertical-drive-start signal STV3 is the output of a second AND gate 620 which receives as its inputs, the first vertical-drive-start signal STV1 and the user-selection signal USS inverted by an inverter 610.

The correlation among the input first vertical-drive-start signal STV1, the input user-selection signal USS, the output second and third vertical-drive-start signals STV2 and STV3 is shown in FIG. 6. Specifically, when the user-selection signal USS is “1”, the gate signals are applied in the order counted from the uppermost gate line to the lowermost gate line of the panel unit 100 is inputted, and when the user-selection signal USS is “0”, the gate signals are applied in the order counted from the lowermost gate line to the uppermost gate line of the panel unit 100. In accordance with the first vertical-drive-start signal STV1 and the user-selection signal USS, the values of the second and third vertical-drive-start signals STV2 and STV3 are determined. The first vertical-drive-start signal STV1 is outputted from the timing-control unit 150.

According to the present invention, the gate drive control unit 120 is not limited to the construction as illustrated in FIG. 5, but may be any circuit that satisfies the correlation among the first vertical-drive-start signal STV1, the user-selection signal USS, and the second and third vertical-drive-start signals STV2 and STV3 inputted to the gate-drive unit 105, as shown in FIG. 6.

FIG. 7 is a view illustrating an exemplary embodiment of the grayscale-voltage-generation unit of FIG. 1, according to the present invention.

Referring to FIG. 7, the grayscale-voltage-generation unit 140 selectively provides the first grayscale voltage group or the second grayscale voltage group. Specifically, when the gate-drive unit 105 provides the gate signals in the first order, the grayscale-voltage-generation unit 140 provides the first grayscale voltage group, and when the gate-drive unit 105 provides the gate signals in the second order, the grayscale-voltage-generation unit 140 provides the second grayscale voltage group.

The grayscale-voltage-generation unit 140 includes a plurality of resistor arrays 810 and 820, and a selection unit 830 which receives the user-selection signal USS as a control signal.

In the resistor arrays 810 and 820, a plurality of resistors R11, R12, . . . , R1n, and R21, R22, . . . , R2n are connected in series. Voltages r11, r12, . . . , r1n, and r21, r22, . . . , r2n of the connection nodes between the resistors R11, R12, . . . , R1n, R21, R22, . . . , R2n are outputted as the first and second grayscale voltage groups. The selection unit 830 receives the user-selection signal USS, and transfers the first grayscale voltage group (e.g., voltages outputted from r11, r12, . . . , r1n) outputted from the resistor array 810, or transfers the second grayscale voltage group (e.g., voltages outputted from r21, r22, . . . , r2n) outputted from the resistor array 820.

As mentioned above, the grayscale-voltage-generation unit 140 includes the first and second resistor arrays 810 and 820. This is because the grayscale characteristic of the panel unit 100 may be changed since the sub-pixels which constitute one pixel have the same or different grayscales according to the order of the turn-on of the gate lines. That is, in order to select the corresponding grayscale voltage group according to the changeable grayscale characteristic, the grayscale-voltage-generation unit 140 includes the first and second resistor arrays 810 and 820.

The voltage values outputted form the first resistor array 810 and the second resistor array 820 should differ. To make the voltage values differ from one another, various methods for differently setting the values of resistors R11, R12, . . . , Rln included in the first resistor array 810 and the values of resistors R21, R22, . . . , R2n included in the second resistor array 820 can be used.

Although the current exemplary embodiment of the grayscale-voltage-generation unit 140 includes a plurality of resistor arrays, as shown in FIG. 7, alternatively, according to another exemplary embodiment, the grayscale-voltage-generation unit 140 may include one resistor array and output one grayscale voltage group irrespective of the order of the turn-on of the gate lines. Further, according to another exemplary embodiment, the grayscale-voltage-generation unit 140 is included in the data-drive unit 130, and outputs a grayscale voltage corresponding to a data signal received by the data-drive unit 130.

As described above, according to exemplary embodiments of the present invention, the liquid crystal display can selectively display an image having a high visibility or an image having a high luminance in response to a user's need.

While the present invention has been shown and described with reference to some exemplary embodiments thereof, it should be understood by those of ordinary skill in the art that various changes in form and details may be made therein, without departing from the spirit and the scope of the present invention as defined.

What is claimed is:

1. A liquid crystal display comprising:
a panel unit comprising a plurality of gate lines, a plurality of data lines, and a plurality of pixels, each pixel being coupled to a gate line and a data line and comprising a plurality of sub-pixels;
a data-drive unit which provides a plurality of data signals to the plurality of data lines; and
a gate-drive unit which provides a plurality of gate signals to the plurality of gate lines in a first order or in a second order,
when the gate-drive unit provides the gate signals in the first order, the plurality of sub-pixels of the respective pixel are charged with different pixel voltages, and when the gate-drive unit provides the gate signals in the second order, the plurality of sub-pixels of the respective pixel are charged with a same pixel voltage.

2. The liquid crystal display of claim 1, wherein the gate-drive unit provides the plurality of gate signals in the first order or in the second order according to a user-selection signal received.

3. The liquid crystal display of claim 1, wherein the gate-drive unit comprises a first to N-th (where N is an integer) gate drivers,
when a vertical-drive-start-signal is applied to the first gate driver, the gate-drive unit provides the gate signals in the first order and when the vertical-drive-start-signal is applied to the N-th gate driver, the gate-drive unit provides the gate signals in the second order.

4. The liquid crystal display of claim 3 further comprises a switch for changing application direction of the vertical-drive-start-signal to the first gate driver or the N-th gate driver according to a user-selection signal.

5. The liquid crystal display of claim 1, wherein the gate-drive unit comprises:
a gate drive control unit which receives a first vertical-drive-start signal and a user-selection signal, and which selectively provides a second vertical-drive-start signal or a third vertical-drive-start signal; and
a gate-signal-providing unit which receives the second vertical-drive-start signal and provides the plurality of gate signals in the first order, receives the third vertical-drive-start signal and provides the plurality of gate signals in the second order.

6. The liquid crystal display of claim 5, wherein the gate drive control unit comprises:
a first AND gate which combines the first vertical-drive-start signal and the user-selection signal, and outputs the second vertical-drive-start signal; and
a second AND gate which combines the first vertical-drive-start signal and an inverted second vertical-drive-start signal, and outputs the third vertical-drive-start signal.

7. The liquid crystal display of claim 5, wherein the gate-signal-providing unit comprises a plurality of integrated circuits mounted on a flexible film.

8. The liquid crystal display of claim 7, wherein the plurality of gate lines comprise first to n-th (where n is an integer) gate lines successively arranged;
the plurality of integrated circuits comprise first to k-th (where, k is an integer) integrated circuits successively arranged, the first integrated circuit provides the gate signal to the first gate line, and the k-th integrated circuit provides the gate signal to the n-th gate line; and
the second vertical-drive-start signal-is provided to the first integrated circuit, and the third vertical-drive-start signal-is provided to the k-th integrated circuit.

9. The liquid crystal display of claim 1, wherein the plurality of gate lines comprise first to n-th (where n is an integer) gate lines successively arranged, and the plurality of data lines comprise first to m-th (where m is an integer) data lines; and
wherein the respective pixel comprises:
a first sub-pixel comprising a first liquid crystal capacitor, and a first switching element including a control terminal connected to an a-th (where, 1≦a≦n−1) gate line, an input terminal connected to an b-th (where, 1≦b≦m) data line, and an output terminal connected to the first liquid crystal capacitor;
a second sub-pixel comprising a second liquid crystal capacitor, and a second switching element including a control terminal connected to the a-th (where, 1≦a≦n−1) gate line, an input terminal connected to the b-th (where, 1≦b≦m) data line, and an output terminal connected to the second liquid crystal capacitor; and
a voltage-adjustment unit comprising a down capacitor, and a third switching element including a control terminal connected to the (a+1)-th gate line, an input terminal connected to the output terminal of the second switching element, and an output terminal connected to the down capacitor.

10. The liquid crystal display of claim 9, wherein the voltage-adjustment unit further comprises:
an up capacitor connected between the output terminal of the third switching element and the output terminal of the first switching element.

11. The liquid crystal display of claim 1, further comprising a grayscale-voltage-generation unit which provides grayscale voltage groups for generating the data signals to the data-drive unit,
when the gate-drive unit provides the gate signals in the first order, the grayscale-voltage-generation unit provides a first grayscale voltage group, and when the gate-drive unit provides the gate signals in the second order, the grayscale-voltage-generation unit provides a second grayscale voltage group which is different from the first grayscale voltage group.

12. The liquid crystal display of claim 11, wherein the grayscale-voltage-generation unit provides the first grayscale voltage group or the second grayscale voltage group according to a user-selection signal received.

13. The liquid crystal display of claim 1, further comprising a timing-control unit which receives image data and provides a color signal for an image display to the data-drive unit,
when the gate-drive unit provides the gate signals in the first order, the timing-control unit operates in a First-In First-Out manner, and when the gate-drive unit provides the gate signals in the second order, the timing-control unit operates in a Last-In First-Out manner.

14. A liquid crystal display comprising:
a panel unit comprising a pixel region comprising a first switching element connecting to a first sub-pixel region, a second switching element connecting to a second sub-pixel region and a third switching element connecting a floating electrode to the second pixel region; a data-drive unit which provides a plurality of data signals to a plurality of data lines; and
a gate-drive unit which provides a plurality of gate signals to a plurality of gate lines in a first order or a second order,
when the gate-drive unit provides the gate signals in the first order, the first and the second sub-pixel regions are charged with different pixel voltages, and when the gate-drive unit provides the gate signals in the second order, the first and second sub-pixels are charged with a same pixel voltage.

15. The liquid crystal display of claim 14, wherein the gate-drive unit comprises a first to N-th (where N is an integer) gate drivers, when a vertical-drive-start-signal is applied to the first gate driver, the gate-drive unit provides the gate signals in the first order and when the vertical-drive-start-signal is applied to the N-th gate driver, the gate-drive unit provides the gate signals in the second order.

16. The liquid crystal display of claim 14, wherein the gate-drive unit comprises a first to N-th (where N is an integer) gate drivers,
when a first vertical-drive-start-signal is applied to the first gate driver, the gate-drive unit provides the gate signals in the first order and when a second vertical-drive-start-signal is applied to the N-th gate driver, the gate-drive unit provides the gate signals in the second order.

17. A method of driving a liquid crystal display comprising;
providing a panel unit having a plurality of gate lines, a plurality of data lines, and a plurality of pixels, each pixel being coupled to a gate line and a data line and comprising a plurality of sub-pixels;
providing a plurality of data signals to the plurality of data lines;
charging the plurality of sub-pixels of the respective pixel with different pixel voltages by providing a plurality of gate signals to the plurality of gate lines in a first order; and
charging the plurality of sub-pixels of the respective pixel with a same pixel voltage by providing a plurality of gate signals in a second order which is different from the first order.

18. The method of claim 17, wherein the plurality of gate signals are provided in the first order or in the second order according to a user-selection signal.

19. The method of claim 17, wherein the plurality of gate lines comprise first to n-th (where n is an integer) gate lines successively arranged, and the plurality of data lines comprise first to m-th (where m is an integer) data lines; and
wherein the respective pixel comprises:
a first sub-pixel comprising a first liquid crystal capacitor, and a first switching element including a control terminal connected to an a-th (where, 1≦a≦n−1) gate line, an input terminal connected to an b-th (where, 1≦b≦m) data line, and an output terminal connected to the first liquid crystal capacitor;
a second sub-pixel comprising a second liquid crystal capacitor, and a second switching element including a control terminal connected to the a-th (where, 1≦a≦n−1) gate line, an input terminal connected to the b-th (where, 1≦b≦m) data line, and an output terminal connected to the second liquid crystal capacitor; and
a voltage-adjustment unit comprising a down capacitor, and a third switching element including a control terminal connected to the (a+1)-th gate line, an input terminal connected to the output terminal of the second switching element, and an output terminal connected to the down capacitor.

20. The method of claim 19, wherein charging the plurality of sub-pixels by providing the plurality of gate signals to the plurality of gate lines in the first order comprises:
applying an a-th gate signal to the a-th gate line to charge the first liquid crystal capacitor and the second liquid crystal capacitor, and then
applying an (a+1)-th gate signal to the (a+1)-th gate line to occur charge sharing between the second liquid crystal capacitor and the down capacitor.
